(19) United States
(12) Patent Application Publication
(10) Pub. No.: US 2025/0285065 A1
(43) Pub. Date: Sep. 11, 2025

(54) CATTLE PERFORMANCE INDEX METHOD AND APPARATUS

(71) Applicant: Patterson Companies, Inc., Saint Paul, MN (US)

(72) Inventor: Steve Trew, Amarillo, TX (US)

(21) Appl. No.: 19/075,668

(22) Filed: Mar. 10, 2025

Related U.S. Application Data
(60) Provisional application No. 63/563,717, filed on Mar. 11, 2024.

(51) Int. Cl. G06Q 10/0639; A01K 29/00; G06Q 50/02

(52) U.S. Cl. CPC G06Q 10/06393; A01K 29/005; G06Q 50/02

(57) ABSTRACT

The present invention relates to a method and apparatus for management of livestock though data monitoring and analysis. In particular, livestock performance indicators are collected and compiled through automated computer controlled means into a single index that can be used to evaluate a segment of livestock relative to a general population of livestock, and in further particularity the invention is applied to cattle.

### RELATED APPLICATIONS

The present application claims priority to and incorporates by reference U.S. Provisional Patent Application No. 63/563,717 filed on Mar. 11, 2024.

### BACKGROUND OF THE INVENTION

### Field of the Invention

The present invention relates to a method and apparatus for management of livestock though data monitoring and analysis. In particular, livestock performance indicators are collected and compiled through automated computer controlled means into a single index that can be used to evaluate a segment of livestock relative to a general population of livestock, and in further particularity the invention is applied to cattle.

### Background

Livestock production is a demanding enterprise requiring substantial resources to ensure best results. Increasingly, livestock producers rely on technological means to improve operational efficiency and handle major aspects of livestock operations.

Such technology includes advanced data collection systems and software applications that process the data collected. Virtually all aspects of cattle production are now performed with the assistance and/or under the control of technology.

Livestock management software systems help farmers and ranchers record and keep track of livestock from birth to sale, and store data regarding nearly all events of animals' lives as well as the business aspects of livestock production. This applies to all types of livestock and animals, including cattle, poultry, pig, sheep, goats, lambs, and the like. With these type of systems, one can keep track of the number of animals on the farm, costing and performance metrics, as well as tracking financial costs associated with raising, caring for, and the sale of animals. This can include feed yard accounting, feeding plans that track the amount of food consumed by each animal in an operation, animal health and identification and record keeping, inventory and commodity management, financial management, pasture and grazing and animal location systems, tracking due dates and key events, and general management of livestock business operation.

With these advancements, many problems are solved, but new problems arise. In the past, management of livestock operations relied on experience, instinct, and observation. It could be said that livestock operators had too little data to make decisions and relied on expertise developed over time instead. Advanced management systems greatly improved the situation, but as a consequence operators can still lack visibility into their operations because they have too much data. It can be difficult to process and interpret all the data, resulting in an inability to understand what the data is saying, and notably understand what if anything the data is saying about a particular livestock operation compared to others operations, or within an operation. This leads to problems such as making incorrect decisions, overlooking problems, and failing to spot troublesome trends before they become major problems.

Thus, a need exists for a method and apparatus to efficiently analyze large amounts of data from multiple sources in connection with livestock operations that does not suffer from the drawbacks associated with the prior art.

### BRIEF DESCRIPTION OF THE FIGURES

FIG. 1 is a screen shot of a data table of the present invention.

FIG. 2 is a first data table.

FIG. 3 is a second data table.

### DETAILED DESCRIPTION OF THE PREFERRED EMBODIMENTS

In the Figures, a method and apparatus is shown for compiling various livestock performance indicators into a single index that can be used to evaluate a segment of livestock relative to a general population of livestock, and in further particularity the invention is applied to cattle.

The present invention is carried out though the use of several interconnected technology systems, including interconnected or networks computer systems, and under the control of programing elements executing on such systems. Several technologically systems are used to collect data associated with livestock operations. The present invention utilizes a broad based data collection and analysis system that relies on several core elements.

First, animal level sensors are used where unique identifiers can be assigned to individual animals and allow for collection of data described herein for each animal in a heard or group of animals. The sensors are affixed to animals or positioned in key locations inside their habitats to allow for identification of individual animals that make up a larger population. Second, data collection devices are placed on equipment that livestock interact with such as feeding systems, watering stations, milking stations, weights and scales, and the like to track livestock interaction with such systems on an individualized basis and collect data relating thereto. Third, data transmission systems such as wireless technologies like Wi-Fi, Bluetooth, or similar systems enable smooth data transfer between the above sensors and systems and downstream systems that read, store, and analyze the data. Fourth, data collection and analysis systems such as livestock management software systems running on remote computing devices such as through SaaS or cloud based software systems, or similar software deployed on servers located near the livestock operations, store, arrange, and display the above referenced data for users such as livestock managers.

Further, animal level sensors collect data about livestock and their surroundings. This can include tracking vital signs, body temperature, heart rate and other biological metrics of animals. Also, environmental sensors can record the temperature, humidity, and air quality of the livestock's living space. Such sensors can include ear tags, RFID sensors, GPS based sensors, subcutaneous sensors, transponders, and the like. This data is forwarded to the central system or SaaS platform either immediately, or on a periodic basis through delayed repetitive data synchronization. The data is collected, stored, and evaluated by data management software systems where the data can be used to evaluate, draw conclusions, and spot trends or abnormalities with regard to the livestock. Statistical analytics tools and algorithms are used to accomplish this purpose, which leads to advancements in animal welfare, productivity, and promoting sustainable livestock practices which were not possible with the prior art.

This system tracks livestock either as a group, or on an individual basis, across a single livestock operation, or multiple operations, including large-scale operations, which per the present invention manage livestock operations in real time using the present technologies, allowing detection of animal tracking information, nutritional patterns, feeding patterns, behavioral patterns, activity levels, calving history, pasture performance, genetic history, animal life events (birth date, weaning date, weaning weight, etc.), veterinary histories, and other vital indicators which are gathered through the present technology resulting in the ability to detect disease and illness faster, see even minor changes in an animal's health, and send alerts enabling quick action, stopping the spread of infections, and limiting financial losses. The present invention comprises a system that increases animal health, and maximize profitability and productivity or livestock facilities.

After the data has been collected, segmented, and compiled into various data fields in a practice management software system a Cattle Performance Index (“CPI”) is calculated. The CPI is a normalized management indicator created by converting any livestock performance information into a percentile score (or index), calculated by comparing a segment of a particular indicator against a larger set of the indicators. The CPI score for a given performance data point indicates how that value relates to the rest of the population as a percentage.

The CPI takes any production livestock data point from a practice management system, or from any other electronic data source, and converts the data into a single percentile value (i.e.: a number whereby a certain percentage of scores fall above and below that number) for purposes of comparing one group's “score” relative to the overall population, as it relates to any livestock production process, collection of data fields, or individual data field. The purpose of the score is to quickly identify differences from one group of animals compared to the overall group in order to spot potential problem areas by seeing how one group of livestock compares to the rest of the population on the data point being analyzed.

The overall population used for the CPI comparison can and will vary. For example, the population could be all the pens in a single feedlot, it could be all the pens in multiple feedlots, one feedlot among a group of feedlots, one customer's livestock compared to another's, or it could be an even larger group such as the population from an entire geographic region or country.

In addition, multiple individual CPI scores can be combined into a composite CPI by multiplying each individual CPI by a “weight” and then aggregating the individual CPIs into a single composite CPI. This allows for identification of broader trends or anomalies, and more or less emphasis can be assigned to individual CPIs in support thereof. Then the composite CPI can be separated into its individual components for more detailed analysis (drilling down).

The following examples of the present invention illustrate implementations of the present invention:

### Example 1

One data point tracked in a management system comprises a measure of the daily nutritional consumption of a group of livestock. If the measure for livestock Group A has a CPI score of 80, while Group B has a CPI score of 10 (both values relative to the overall population in percentage terms), these scores indicate Group B is performing at the bottom of the population while Group A is near the top. Therefore, an inquiry can be made to determine the nature of the difference.
The CPI score of “80” means that 80% of the population has a lower daily consumption than Group A. The CPI score of “10” means that only 10% of the population has a lower daily consumption than Group B.

### Example 2

If comparing carcass quality grade data in a management system, Ranch A's livestock might have a CPI score of 75 for the number of CHOICE carcasses; whereas Ranch B could have a CPI score of 12. These scores would indicate that Ranch B should review its breeding program to improve their livestock's quality grade.
The CPI can be calculated across a wide range of groupings or segments of a broader set of data, for example:
Animal level—the population from which the CPI is derived can be animal data. The CPI for any animal data entry would indicate the animals' performance against the overall animal population, in the particular data category.
Origin level—the population from which the CPI is derived can be sources of livestock. Performance would be ranked by origin, or ranch. The CPI would indicate differences in sources of livestock for the desired key performance indicator (or data category). At the ranch level, this CPI would assist in making decisions to improve the herd, as well as provide guidance on where to focus production improvements.
Intra Feedlot level—the population from which the CPI is derived can be livestock groups within a livestock facility having a single feedlot. The CPI would indicate differences in feedlots relative to the entire facility. Managers could quickly see what groups are performing below average, relative to other feedlots. Feedlot level CPI would be a composite CPI of all data for the given feedlot, and it would be possible to then drill down further to see which individual CPIs in the composite to determine which is having the greatest effect on the overall CPI.
Inter Feedlot level—the population from which the CPI is derived would be livestock feedlots within a livestock facility with a multiple feedlots, and can compare one feedlot to another or to all the other feedlots.
Customer level—the population from which the CPI is derived would be customers of a livestock facility (where the livestock facility is raising cattle for a plurality of different customers). The CPI would indicate differences in the livestock of different customers relative to the entire facility. Customers could see how their cattle are performing, relative to other customers, within one or more feedlots.
Nutritionist level—the population from which the CPI is derived would be feeding-related data points in a facility. Nutritionists could quickly spot problem areas related to their feeding program, and use historical CPI scores to monitor progress towards a desired outcome.
Veterinary level—the population from which the CPI is derived would be health-related data points in a facility. Veterinarians could quickly spot problem areas related to their health program, and use historical CPI scores to monitor progress towards a desired outcome.

At all levels, CPI scores could be the basis for determining the success or failure of many management and financial decisions by setting “target” scores to achieve within a desired period of time and monitoring progress over time toward the target.

CPI data points are calculated based on data stored and processed by the management software systems taken from livestock operations such as from individual livestock, or facility equipment or other sources as described herein above. The CPI is calculated using a percentile function such as the percentile function provided by Microsoft in SQL Server version 2014 and above, which is used to return a CPI ranking a particular segment of a data field against a larger set of data or another subset of the data.

The CPI calculation can be refined by filtering the data to remove “outliers,” or other data that bear indicia of unreliability, so that only data deemed relevant is used. Outliers would include data that are incomplete, and/or non-relevant groups due to size or time, and the like. In addition, filters can be applied that restrict the population to specific sex, location, ownership, origin, etc.

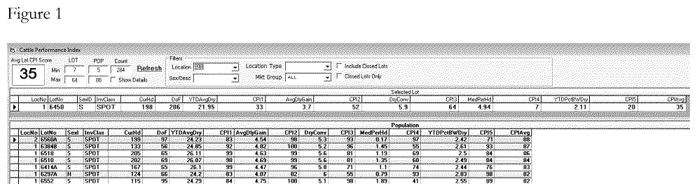

FIG. 1 is a screen shot of the CPI screen in a management software application. The data shows an average overall lot CPI (35 in this case). The lot CPI is a composite CPI of smaller units that are shown in the rows below the composite CPI. Each row in the grid is a sub unit from which the lot CPIis taken. Each row includes several CPIs specific to the sub unit shown in the row, and an average composite CPI for the sub unit in the right most column of the each row. This presentation greatly enhances the ability to identify values that significantly depart from the total population, by providing a CPI value that is normalized and has relative meaning without having to evaluate the underlying data.

The table in FIG. 1 includes the following entries: an overall CPI score for all the data; maximum and minimum CPI scores for the entire population and for each lot (row); a count which is the total number of data points in the population; the rows of the table represent individual groups within a set of several feed lots; the columns show KPI data (defined below) and the CPI for each individual KPI; the last column shows the composite CPI for all KPIs for each feed lot; and filtering options are available to refine the data.

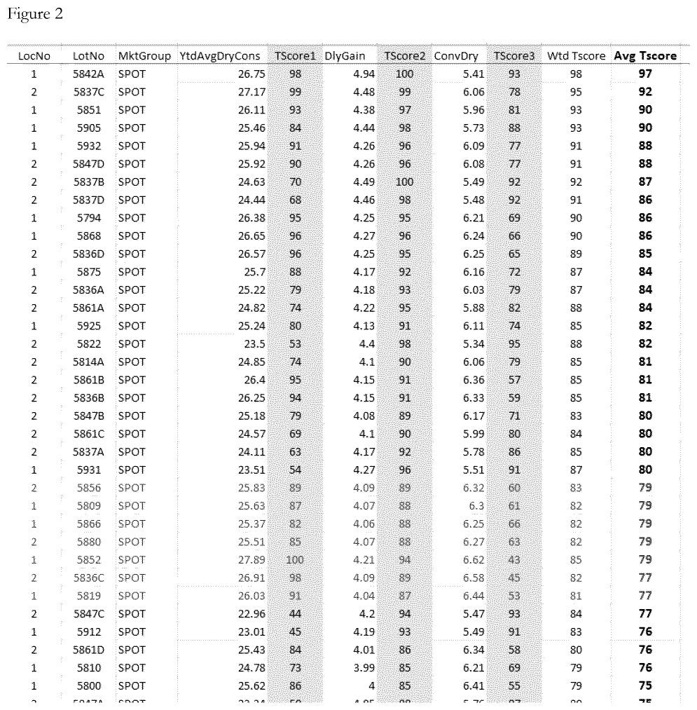

Shown in FIG. 2 is another example of a series of CPI scores. The results are shown in descending average CPI order. The average composite CPI in the right most column is meaningful, however, looking at the underlying individual CPIs that make up the average, reveals deeper anomalies (shown in red).

For example lot 5852, the daily gain scores in the 94th percentile, but the dry conversion scores in the 43rd percentile. This a key the manager can immediately identify, and see an area that needs attention.

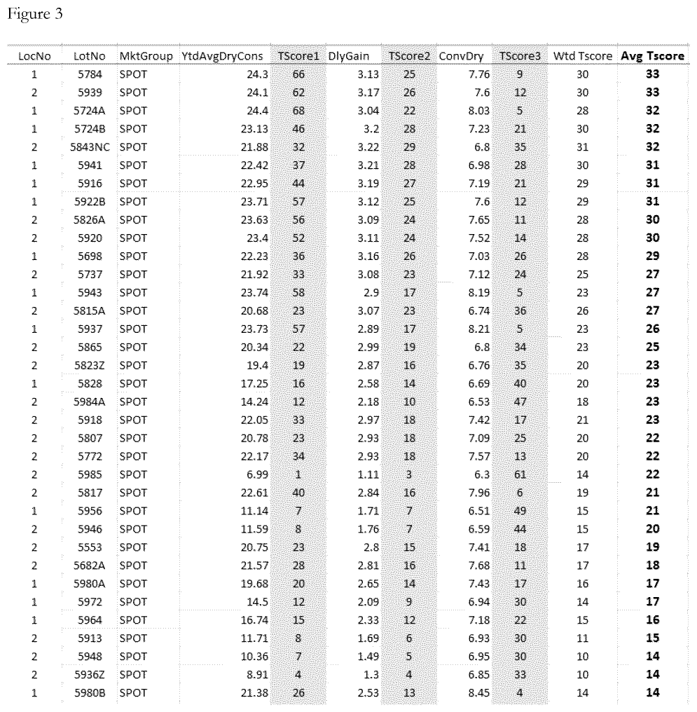

In the chart shown in FIG. 3, looking at the bottom of the average CPI order, the underlying problems in the individual CPIs becomes more obvious.

The CPI is calculated based on categories of data collected from a variety of sources, with each data point represents a quantifiable parameter associated with livestock operations. These categories of data are thus key performance indicators (“KPIs”). The KPI data is particular to an animal, lot, market group, customer, and/or feedlot and can then be used to create the CPI that ranks a subset of the data for a KPI across a larger population of data for the same indicator. This CPI is useful to determine if decisions being made are working, or if changes are needed to bring the segment evaluated into line with the general population.

As such, the CPI process takes raw livestock data points from any electronic data source and converts the data into a single normalized aggregate percentile value for purposes of comparing one or more KPI(s) for some segment of the population relative to the overall population, as it relates to any livestock production process.

The KPIs used can include the following data parameters, as well as others.

| | | |
|---|---|---|
| Daily gain | Dressed weight | Treatment regimes |
| Consumptions | Quality grade | Drug response |
| Conversions | Yield grade | Dressed weight |
| Death loss | REA | Number of employees |
| Medical cost | Premiums | Margins |
| Processing cost | Marbling | Profitability |

The CPI comprises a percentile values and can be applied to any population set, at any level, to create a single score from 0-100. This score represents what percentile of the population that data point falls in.
Example 1: A lot's overall CPI of 98 means that this lot's combined KPI CPIs falls in the 98th percentile (the lot is in the top 2% performers).
Example 2: A feedlot may have five KPIs, each of which has its own CPI for each lot. Each KPI could optionally have a “weight” the feedlot can assign to it based on their desired focus. If all five KPIs were treated equally, they would all have the same weight factor and the total would equal 100% weight, and the overall CPI would be a straight average of the five KPIs. If the user wished to give more weight to one KPI such as daily gain, then the daily gain KPI might be assigned a 60% weight, with the other four KPIs having 10% each. The overall CPI would be calculated as: Overall CPI=(CPI1×% Wgt1)+(CPI2×% Wgt2)+(CPI3×% Wgt3)+(CPI4×% Wgt4)+(CPI5×% Wgt5)

The present invention substantially solves the problems in the prior art by providing a highly useful and quick way to assess the large amounts of data available in data collection systems. The CPI allows for an apple-to-apple comparisons across large data sets of information, and avoid the problem of information overload when trying to review the raw KPI numbers that vary greatly in value and range within a population and from KPI to KPI. This allows livestock operators the ability to spot emerging issues before they become problems, and implement best practices based on solid statistical and data driven trends instead of gut reactions, or ad hoc instinctual judgements.

The present invention is particularly suited for cattle operations but can be applied to a wide variety of livestock and animal production operations where data is collected and data can drive decision-making. While the present invention utilizes automated data collection devices and tools that feed data to network connected computer systems, the invention is adapted for manual data entry too.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A method of determining a performance index (PI) for monitoring a key performance indicator (KPI) associated with an animal, comprising:
a. providing a plurality of sensors to identify a plurality of animals;
b. providing a plurality of data collection devices associated with devices that the animals interact with;
c. providing a data transmission system for transmitting the data for storing and processing;
d. providing a data collection and analysis system using computer controlled operations to collect and analyze the data;
e. grouping the data into one or more sets for analysis; and
f. calculating one or more PIs for the KPIs where the PIs represent an average performance normalized to a percentage to show the performance of one or more of the data sets against the other data sets.

2. The method of claim 1 where the KPI is a factor related to the health of the animals.

3. The method of claim 1 where the KPI is a factor related to the environment of the animals.

4. The method of claim 1 where the sensors are attached to the animals.

5. The method of claim 1 where the PI is a composite PI comprised of multiple KPIs.

6. The method of claim 5 where the individual PIs in the composite PI are weighted to create the composite PI.

7. The method of claim 1 where the animals are cattle.

8. The method of claim 1 where the KPIs are factors associated with the cattle operations.
